(19) United States
(12) Patent Application Publication
(10) Pub. No.: US 2004/0000275 A1
(43) Pub. Date: Jan. 1, 2004

(54) Multi map fuel detection fuel injection

(76) Inventors: Michael Gene McIntyre, El Paso, TX (US); Tracy Dean McIntyre, El Paso, TX (US)

Correspondence Address: Michael Gene McIntyre, 6416 Isla Del Rey, El Paso, TX, 79912, US

(21) Appl. No.: 10/136,418

(22) Filed: May 1, 2002

(51) Int. Cl. F02B 75/12

(52) U.S. Cl. 123/1 A

(57) ABSTRACT

Our invention is new to the art of fuel injection because it enables the fuel injection system to evaluate the properties of the fuel in the system and then choose a base line fuel injection map from a group of maps. This chosen map will be more accurate or a better match to the fuel that is going to be injected. By choosing a map that matches the properties of the fuel that is about to be injected you will have a more precise amount of fuel injected and their by have better fuel economy better power output and lower emissions.

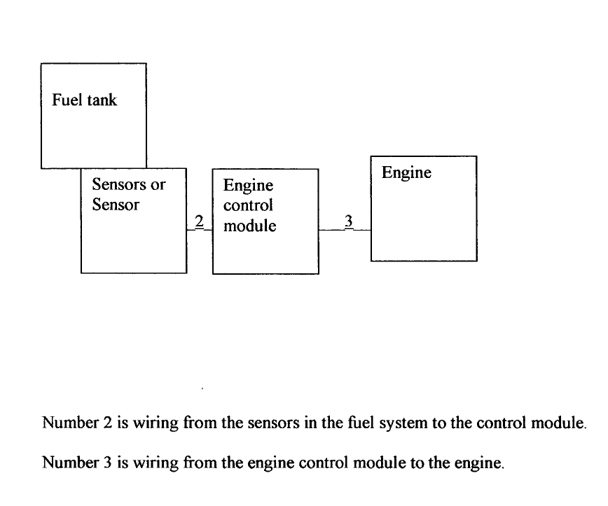

The present invention addresses the above and other needs by providing a method and system to achieve better fuel economy, lower emissions and better performance, than is available in today's fuel injection systems. As disclosed herein, after one or more sensors evaluates the fuel, the control module will choose a base line fuel injection map from a group of maps to more accurately meter and inject the fuel being delivered. This system will work in conjunction with existing fuel injection technologies that are common to anyone skilled in the field of fuel injection. The above-identified methods and systems be utilized alone or in conjunction with other fuel system controlling techniques. additionally, each of the specific steps involved in the processes, described herein are easily modified or tailored to meet the peculiar design and operational requirements of the particular engine and the anticipated operating environment in which the engine is used.

From the foregoing, it should be noted that the invention provides a method and system for the detection of fuel used in an electronically controlled engine. While the invention disclosed herein has been described by us to the best of our ability, numerous modifications and variations can be made thereto by those skilled in the art without departing from the scope of the invention as set forth in the claims or sacrificing all its material advantages.

A fuel injection system that has multiple (1 to infinity) maps of fuel injection curves available to choose from.

Inside of the fuel system of this electronically fuel injected vehicle will be a sensor/sensors that will take readings of the properties of the fuel. These readings will be sent to the control module of the fuel injection system. The control module will decide based on these readings the most appropriate fuel injection map. Once the appropriate fuel injection map has been determined the fuel injection system will perform in a similar manner as current systems. In addition to these features this invention will use some or all of the standard components in today's fuel injection systems. The control module will be modified to accept readings from a bank of sensors located in the fuel system. This bank of sensors will test the quality, characteristics and properties of the fuel. The properties to be evaluated would include but would not be limited to the specific gravity, octane, vapor pressure, sulfur content, oxidation stability, distillation properties, vapor-liquid ratio, phosphorus content, density, relative density, MTBE, ETBE, TAME, DIPE, tertiary-amly alcohol, C1 to C4 alcohol, gasoline-oxygenate blends and fuel temperature. Instead of one base line fuel injection map we will program many base line fuel injection maps into the control module. When the control module encounters a fuel that has a certain characteristic or characteristics the control module will pick the most appropriate map available for that fuels characteristic or characteristics. When the map has been chosen the fuel injection system will use this optional map as the base line map and function the same as today's common fuel injection systems until some other fuel characteristic has been detected. At which point it will switch to another more appropriate map.

The above-identified methods and systems for the identification of fuel in an engine can be utilized alone or in conjunction with other fuel system controlling techniques. Moreover, each of the specific steps involved in the processes, described herein are easily modified or tailored to meet the peculiar design and operational requirements of the particular engine and the anticipated operating environment in which the engine is used.

### CROSS REFERENCE

Not applicable

### FEDERAL SPONSORSHIP

Not applicable

### BACKGROUND

The invention relates to a fuel detection system or identification system of fuel for an electronically controlled engine, and more particularly, to a system that will recalibrate the amount of fuel delivered to an engine after considering the properties of the fuel to be delivered and method for the detection and identification of the fuel used in electronically controlled (fuel injected) internal combustion engines. If the detected fuel is identified as having a certain set of characteristics or characteristic, for example high specific gravity due to alcohol additives, then the control module would choose a map that would inject more fuel for any given set of conditions applied to the fuel injection system. On the other hand if the detected fuel has a low specific gravity, low or no alcohol additives and no sulfur additives then the control module would chose a map that would inject less fuel for any given set of conditions applied to the fuel injection system.

This invention can be added to the existing fuel injection systems on current autos by adding to the fuel injection programming, the ability to choose from multiple base line maps that will be used after the fuel has been evaluated. For example current auto technologies employ a base map and this base map is modified after taking into consideration the conditions applied to various sensors. Current technologies use such sensors as air temperature, air mass, water temperature and so on. With this invention we will use all current technologies and add in the ability to evaluate the fuels' properties. Once the fuel has been evaluated the fuel injection system will choose a map and more accurately inject the proper amount of fuel.

Common fuel injection system use a control model which contains a base line map that will give a basic amount of fuel for any given set of parameters which commonly include RPM & throttle position. After the basic fuel amount has been determined the control module will Add to or subtract from this basic amount of fuel using the information supplied from a myriad of sensors which commonly include water temp, air temp, mass air, load applied to the engine and so on. The final fuel amount will be determined from the forgoing. This is in open loop operation. After the engine gets warmed up to a predetermined temperature the control module will go in to closed loop function IE the o2 sensor will evaluate the amount of o2 in the exhaust stream after all of the previous evaluations happen the o2 sensor will tell the control module that it is rich or lean then the control module will effect an addition or subtraction of the amount of fuel to be injected in to the engine the is an ongoing process. This is a very good way to achieve fuel economy good performance and low emission. However while the engine was in open loop operation it had no ability to evaluate the mistakes it was making with regards to the amount of fuel it was injecting. Do to this shortcoming the engine manufactures tend to run the engine slightly rich to guaranty that there will be no engine damage and or drivability problems do the lean fuel air ratios wile in open loop. Also when in closed loop operation if the throttle is opened quickly the fuel injection has to revert back to the base fuel map in the seconds after the throttle is opened quickly the o2 readings are not considered and during this time the fuel delivery is on the rich side as well.

To make things harder on the manufactures the fuel that is supplied for use in the engine can have different properties. The properties of the fuel have a large barring on how much fuel needs to be injected for proper operation. For example when the fuel at the pumps is oxygenated you will need to inject more of it for proper fuel air ratio this must be factored in to the base fuel map or the engine will run lean during the months that the fuel at the pumps is oxygenated. So it is clear that during the months that the fuel is not oxygenated that the base fuel map will be to rich during warm up and fast throttle opening as well as at other times. Clearly it would be better if the fuel injection system could evaluate the fuel and then compensate for the fuels properties before the fuel is injected.

Although the fuel that is readily available at the pumps is manufactured under tight guidelines there are still large variances in the fuels' properties. For example the fuels' vapor pressure, specific gravity and alcohol content as well as many other additives and properties have an effect on the engines drivability, economy, emissions and power output.

The ASTM Designation: D4814-01a list 6 categories of drivability with respect to fuel vapor pressure alone, the ability to detect the vapor pressure of the fuel being delivered to the engine would allow the control module to correct any drivability problems by choosing the appropriate fuel map for any giving vapor pressure.

Specific gravity of the fuel has a great impact on the amount of fuel that needs to be delivered to the engine to achieve the proper air to fuel ratio. Since the weight of the fuel changes dramatically when alcohol and oxygenated blends are added. It will be advantageous to choose the fuel map after considering the specific gravity or the weight of the fuel.

Fuel temperature will affect the amount of fuel that is needed for the proper fuel air ratio. If the fuel is cold it will remove heat from the intake tract making the intake air denser, consequently the engine will need more fuel for the proper fuel air ratio.

Other onboard tests may be utilized to evaluate fuel to achieve better fuel economy better emissions and better performance. The invention would employ at least all or part of the appropriate test/evaluation processes as found in the ASTM Designation: D 4814-01a Standard Specification for Automotive Spark-ignition Engine Fuel1.

The ability of autos to evaluate the fuel in their own systems and then compensate for a large variety of fuels will allow the fuel manufactures to supply a broader range of fuel that may have more of the alcohol or oxygenate blends which will give cleaner emissions without causing derivability problems.

### BRIEF SUMMARY OF THE INVENTION

The invention is going to enable the fuel injection system to determine the properties of the fuel that is about to be injected in to the engine using information that will be obtained by a sensor or bank of sensors in the fuel system. Using this information the control module will be able to chose a base line fuel injection map from a group of maps that will better suit the fuel that is about to be injected. Choosing a more accurate fuel map will give better fuel economy better power and lower emissions. The most notable improvements will be during the open loop operation of normal fuel injection systems operation but there will also be improvements in the closed loop operations. Prior to going to closed loop operation today's fuel injection systems rely on a map that was manufactured for one type or quality of fuel. However the fuel that is at the pumps today has a large variance in the way it is manufactured. Some fuels are designed to pollute less during government-mandated months of the year. Current fuel pumps have three choices of octane to choose from. Different countries and or states have different regulations on fuel content. If we can ascertains the properties of the fuel prior to injecting them we can improve fuel economy and drivability. As well as decrease emissions. additionally we will be able to use a broader range of fuels in our vehicles thereby allowing the fuel manufactures to use more anti pollutant fuel combinations as well as lower the cost of fuel production.

### BRIEF DESCRIPTION OF THE DRAWINGS

The above and other aspects, features, and advantages of the present invention will be more apparent from the following, more descriptive description thereof, presented in conjunction with the following drawings, wherein:

FIG. I is a flow chart showing the fundamentals of the multi map fuel detection fuel injection system.

### DETAILED DESCRIPTION OF THE INVENTION

The following description is of the best mode presently contemplated for carrying out the invention. This description is not to be taken in a limiting sense, but is made merely for the purpose of describing The general principals of the invention. The scope and breadth of the invention should be determined with reference to the claims.

The invention will contain a bank of sensors or sensor that will test the properties of the fuel in the fuel system. The information from the bank of sensors will be received by the fuel injection control module the control module will ascertain what the properties of the fuel are. Using this information the control module will pick a fuel injection map from a group of programmed maps. The maps that are in the module are maps that have been proven to work properly with the engine that the control module is installed on and for a broad range of fuels that the engine may encounter under any circumstance. For example the control module will have many maps. The map numbered 1 will be the default map and this map would be what you would have in any of today's autos this map will be derived using the standard method of today. The maps numbered greater that 1 will have different values these values will allow the engine to function perfectly with other than the ideal fuel. For instance map 501 will be written to allow the engine to run perfectly with 1 percent addition of MTBE added. Map number 502 will be written to allow the engine to run perfectly with 2 percent MTBE added. Map number 503 will be for 3 percent and so on. Maps 600 through 699 will be for combination of MTBE and some other additive. The control module will have has many maps as there are different fuel combination, and beyond that it will have enough maps to accommodate fuel combinations that are not at the pumps to day but that may be available in the future. If fuel additives have counter acting properties, the control module will pick the most appropriate map for the combination of additives or properties of the fuel.

The above-identified methods and systems for the identification of fuel in an engine can be utilized alone or in conjunction with other fuel system controlling techniques. Moreover, each of the specific steps involved in the processes, described herein are easily modified or tailored to meet the peculiar design and operational requirements of the particular engine and the anticipated operating environment in which the engine is used.

What is claimed is:

1. A fuel injection system of a motorized vehicle that has on board the vehicle and inside the fuel system a sensor or bank of sensors that continuously reads the properties of the fuel in the system. The properties to be read would include but not be limited to: specific gravity, octane, vapor pressure, sulfur content, oxidation stability, distillation properties, vapor-liquid ratio, phosphorus content, density, relative density, MTBE content, ETBE content, TAME content, DIPE content, tertiary-amly content, alcohol content, C1 to C4 alcohol content, gasoline-oxygenate blends, fuel temperature, etc; Once the properties of the fuel have been ascertained the information will be sent to the control module of the fuel injection system.

2. A fuel injection system of a motorized vehicle that has a control module with multiple maps (1 to infinity) of fuel injection curves to choose from. When prompted by incoming information this control module will choose a map, from the selection of maps, that correlates to the incoming information.

3. A fuel injection system of a motorized vehicle that has on board the vehicle and inside the fuel system a sensor or bank of sensors that continuously reads the properties of the fuel in the system. The properties to be read would include but not be limited to: specific gravity, octane, vapor pressure, sulfur content, oxidation stability, distillation properties, vapor-liquid ratio, phosphorus content, density, relative density, MTBE content, ETBE content, TAME content, DIPE content, tertiary-amly content, alcohol content, C1 to C4 alcohol content, gasoline-oxygenate blends, fuel temperature, etc; Once the properties of the fuel have been ascertained the information will be sent to the control module of the fuel injection system. Additionally this fuel injection system has a control module with multiple maps (1 to infinity) of fuel injection curves to choose from. The control module will receive the readings from the sensor/sensors. Then the control module will choose a map from the available maps that correlates to the incoming information from the sensor/sensors. Once the map is chosen the control module will correctly and accurately inject fuel into the engine based on the fuels properties. By using multiple maps and choosing a map based on the fuels properties better power, fuel economy and drivability will be attained. Additionally lower emissions will be achieved. This system will work in conjunction with existing fuel injection technologies that are common to anyone skilled in the field of fuel injection.
